(19) United States
(12) Patent Application Publication
(10) Pub. No.: US 2016/0036365 A1
(43) Pub. Date: Feb. 4, 2016

(54) Electromechanical power system

(71) Applicant: James Bryant, Philadelphia, PA (US)

(72) Inventor: James Bryant, Philadelphia, PA (US)

(21) Appl. No.: 13/957,966

(22) Filed: Aug. 4, 2014

(51) Int. Cl. H02P 25/10; B60L 11/18

(52) U.S. Cl. CPC H02P 25/102; B60L 11/1803

(57) ABSTRACT

The (6) power transformer that transmits power that links to (7) electromagnetic wound with a coil in a magnetic field as an amplifier of electrical amperes in a circuit, which an electromagnetic induction that generates overall power of the magnetomotive force as an alternating current (AC) induction motor. The (10) electromagnetic rotor bar as the magnetic rotating force that connects (9) the slip ring which supplies the magnetic current in an air gap (that interacts with electromagnetic induction) to the rotor bar that connects to (14) the fly wheel, a lever that generates torque. In accord with various petrol engine specifications the electromechanical power system can power passenger vehicles, trucks, buses, tractors, cranes, motorcycles, boats, locomotives, ships and other mechanical systems such as hydraulic engines, which include backhoes, excavators, and bulldozers; also it is the driving force of the rotors of pumping systems and electrical generating systems. It is also the driving force electrical generating system rotors for the alternator to produce electric-thermal power to generate steam or very hot air to drive turbine alternators in power plants, desalination plants, or large ships. In this electric power system using direct current (DC), (19) the battery is a source of power which links to electromagnetic coil in a series circuit that connects to resistors that link to the capacitor and connects to the power transformer that links to the (AC) reluctance motors that is the driving the force for the rotor that combines with a fan which is a movable compressor that generates air flow through a duct tube to the thruster for propulsion systems or propellers, which can be found in aircraft engines.

This system also converts petrol-powered emergency power generator systems for home and businesses to direct current (DC) electric power systems such as the Generac II Emergency Power System Generator through the same process as for the portable electric generator in accordance to the specifications. In this electromechanical power system, the AC and DC can be alternatives to all energy sources.

This invention will produce power output similar to the petrol-powered engines such as the 2013 Buick Enclave engine for which the specifications are an overall electrical-powered engine and a direct current, electric-power system that powers a portable electric generator.

This is an electrochemical generator that outputs 12 volts. It is a source of power that is a rechargeable battery, which produces power to an inductor as an electromagnetic coil that amplifies amperes which link to a resistor in a series circuit that generates the output of power for a 24-volt, 1.5 kw DC motor that supplies the driving force for the rotor of a generator that outputs 200 amperes in accord to the 2013 Buick Enclave generator. This combination acts as a dynamotor, which interlinks components and units to develop the electromechanical power system that the dynamotor links to the capacitor that distributes power to the iron core power transformer. A mutual inductance primary load (LP) winding interacts in a magnetic field not connected to the secondary load (LS) that steps up the winding as it connects to the electromagnetic induction coil. The total amount of power output is the same as the output of the 2013 Buick Enclave's engine (288 HP at 6,300 rpm) or is 27,648 kw at 6,300 rpm, which is the magnetomotive force. The variation of magnetomotive force output that determines in the various amounts of ampere output in the circuit is regulated from the variable resistor (Rheostat).

The flow charger is a voltage regulator that distributes power as a capacitor to recharge the battery while the system is operating to interlink components in a series circuit as the power resource. The flow charger connects to the distributed transformer that connects to the rotor, of which the fly wheel is the driving force of the rotary generator, which supplies power through the distributed transformer to the flow charger that connects to the battery terminals which serve as the power resource.

The accelerator is the integral lever of the variable resistor which is a pedal to operate manually with a spring attached to an extension cable that controls the power output from a distance, mainly inside a vehicle. The rotor bar is a shaft that is interconnected to the fly wheel that is a lever which generates a torque as a rotational force. This lever applies the fulcrum principle that engages in the transmission of power; it is also an apparatus that links to an alternating current induction motor 27,648 kw at 6,300 rpm and torque 270 lb-ft at 3,400 rpm that correlates with the magnetomotive force to provide the adequate amount of power according to the specifications of the 2013 Buick Enclave petrol-powered engine whose fly wheel can operate as a component in the electromechanical power system or other petrol-powered engine specifications. The rotor bar is insulated at both ends and surrounds the inside space of the frame (housing) to prevent an exterior electroshock from the magnetic field of conductance. The cubic dimension of the electromechanical power system, in accord with the 2013 Buick Enclave petrol-powered engine, has dimension specifications with a modification for the variable units and components to be precise and to adapt to the fixture of the frame (mechanical structure).

The 2013 Buick Enclave's electric motor operates at 217 watts, 3,564 rpm no torque. The 2013 Buick Enclave's petrol-powered engine has 288 horsepower, 6300 rpm and its torque is 270 lb-ft 3,400 rpm. The electric-powered motor is 75% of the petrol-powered engine in the 2013 Buick Enclave. The overall electric power of the electromechanical power system is similar to the torque of the 2013 Buick Enclave (27,648 kw) and torque of 270 lb-ft 3,400 rpm (revolutions per minute).

Any other conventional electric motor lacks the power compared to conventional petrol-power engines such as the 2013 Buick engine. The electromechanical power system in comparison to the 2013 Buick Enclave's electric motor and any other conventional electric motor that generates power is a matter of torque similar to the 2013 Buick Enclave's petrol-powered engine. The electromechanical power system differential is unique compared to the 2013 Buick Enclave petrol-powered engine and any other petrol-powered engine that is a renewable power source, which the 2013 Buick Enclave petrol-powered source can be replenished at a fuel tank for approximately 22 gallons and the electromechanical power system also has no carbon dioxide emissions; however, the 2013 Buick Enclave does produce carbon dioxide emissions.

In the process of operation, the electromechanical power system is much safer than the 2013 Buick Enclave petrol-powered engine which is at the risk of uncontrollable explosion and other hazards that can occur from the petrol fuel that it consumes.

The conversion of the 2013 Buick Enclave's 288 hp engine to electrical power:

1 hp=96 watts×288 hp or 27,648 kw magnetomotive force at 6,300 rpm

The electromechanical power system is more economical to operate than the 2013 Buick Enclave's petrol-powered engine because it does not use petrol fuel as its source of power. Furthermore, the source of power is a rechargeable battery. It is an efficient electric power source and also environmentally friendly to animals and people as well as the ecology.

The overall electric power system that derives from a direct current (DC) links to the electromagnetic coil to power a portable electric generator.

The combination of components that interconnect to produce power for a portable electric generator include: The battery (12 volts), a rechargeable source of power that connects to an inductor with which an electromagnetic coil amplifies the amount of amperes that connect to resistors that are the electromotive force (voltage) in a series circuit which develops a power output of 175 VDC (voltage direct current), 10 amperes to the full load of a 2 kw 1,750 rpm DC motor.

The flow charger is a voltage regulator that connects to the generator exciter which grounds to the lug connecting to the capacitor in a combination of inductors and resistors as a unit to supply power to the source of power, the 12 volt, rechargeable battery.

The electric power system, an electromagnetic coil, direct current (DC) renewable power source, which is uniquely different when compared to a gas-powered engine can operate inside and does not produce the carbon dioxide emissions like gas-powered engines do. The electric power (DC) is more reliable than other renewable energy systems such as solar and wind energies. Solar power depends on the sun as its power source, and wind depends on the flow of the air for its power as a source to drive a turbine to generate electricity. The electric power system (direct current) is the interlinking of components and units that form the inertia or self-contained power source and does not depend on an outside power source; also it can operate in any location.

The summary of the electromechanical power systems:

The 2013 Buick Enclave's petrol-powered engine that converts to an overall electric power engine

The Coleman Powermate 3000 watt Portable Electric Generator is a gas-powered 5.5 hp HV converted to electric DC motor 2 kw.

The (1) rechargeable battery, the source of power that connects to (2) an inductor, the coil that amplifies amperes that power the DC motor interconnects to a generator as a (4) dynamotor which is a power plant unit that connects to a (5) capacitor in which distributed power that connects to the (6) iron core power transformer provide the electromotive force (EMF) or voltage that connects to (7) the electromagnetic wound as the induction coil connects to the (8) variable resistor that controls the amount of current (amperes) to the magnetic field that that is connected to a power controller which connects to the (9) slip ring. An air gap between the rotor bar interacts with the electromagnetic induction which produces an output of magnetomotive force. (10) The electromagnetic rotor bar is the rotating force or an alternating current induction motor. The (14) flywheel is a lever that produces torque which is the rotating force or the amount of winding in the coil as the resistance produces the EMF's or voltage and the amount of turn in the loop as an inductance of amp's to interact in a magnetic field to generate the amount of watt-power output as the formula: voltage×amperage=wattage.

The (13) distributed transformer connects to the generator that connects to the (11) flywheel as the driving force of the rotary generator. (18) The flow charger connects to the battery to recharge it. (17) The vent and inflow of air to the electric engine acts as a cooler. The (15) pulley transmits power through a belt; the (16) frame of a mechanical structure is a fixture which houses a stationary variable electrical apparatus which is an interconnection of units and components which link to form an electrical power generating system.

The (12) switch connects to the battery to turn on and off the power in the circuit. A (3) circuit breaker is an interrupter which cuts off the power in case of mechanical malfunction.

Direct current (DC) electric power system which powers a portable electric generator:

A (19) battery (source of power) that is rechargeable, and which the electrochemical generator uses to generate power as direct current that connects to an electromagnetic coil in a series circuit that links to a resistor to power a direct current (DC) motor.

A (20) 750 rpm reluctance direct current motor with rotary drive force that links to a rotary generator that produces output of power that connects to a circuit breaker.

A (21) flow charger which is a voltage regulator to recharge the battery while it is operating as a capacitor and which connects to the battery terminals and generator exciter.

The advantage of the electromechanical power system over the petrol-powered engine (2013 Buick Enclave) is that it is a renewable power source for which the rechargeable battery is the source of power. It is free of carbon dioxide emissions as opposed to petrol-powered engines (2013 Buick Enclave). The power is the same as those in petrol-powered engines versus the conventional electric engine which is not the same as 75% of petrol-powered engines.

The electric power system direct current in which the electromagnetic coil powers a portable electric generator can operate inside buildings with no carbon dioxide emissions as compared to gas-powered engines whose carbon dioxide emissions and renewable power source emanate from the need to use gas for power.

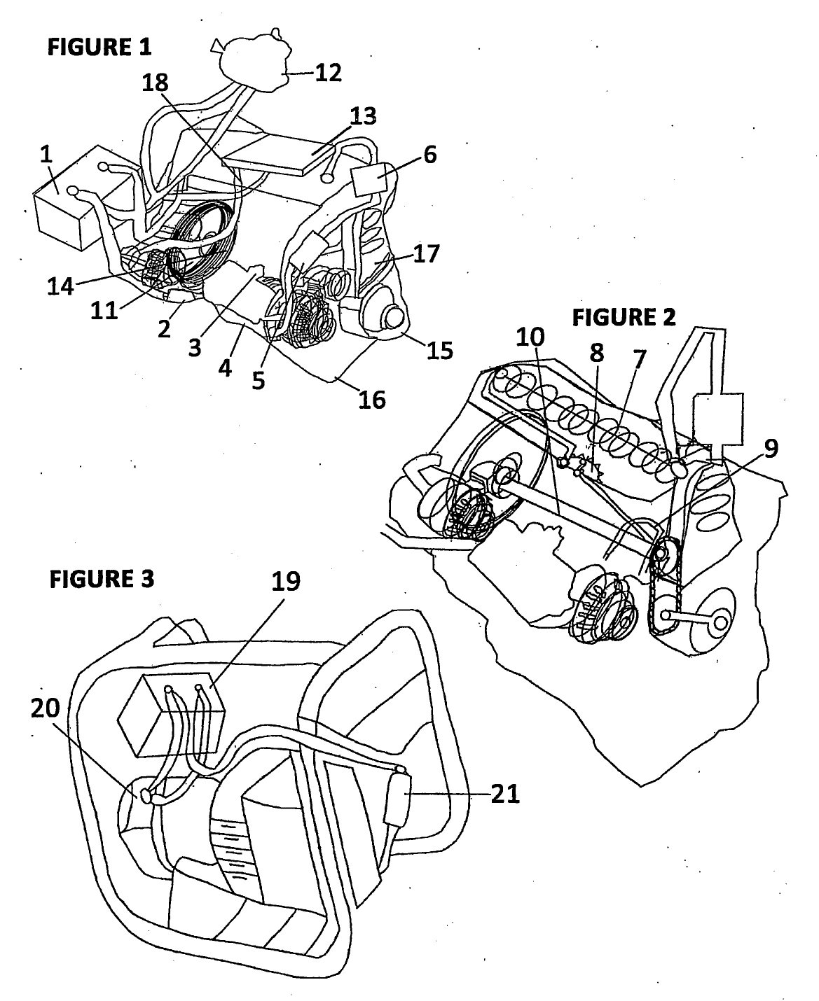

The drawing, Page 8, FIG. 1, 1-6 numbers; 11-18 numbers, exterior view.

(1) Rechargeable battery (source of power).

(2) Inductor, an amplifier of amperes. (3) Circuit breaker cuts off the power in case of malfunction. (4) 24 volt DC motor and generator combined (dynamotor). (5) Capacitor distributes power. (6) Power transformer that is a transmitter of power (interior view) Page 8, FIG. 2, Drawings 7-10 Numbers. (7) Electromagnetic wound is a coil that links to a magnetic field amplifies amperes in a circuit that generates a magnetomotive force output according to Faraday's Law of Electromagnetic induction. (8) Power controller operates according to Ohm's law of resistance and determines variable amounts of amperes in a magnetic circuit as a Rheostat. (9) Slip ring interacts with the electromagnetic induction.

Lenz's Law determines the pole direction of magnetomotive force; the right is the south pole. (10) Electromagnetic Rotor Bar. The amperes and magnetic influx that generates a magnetomotive force that is electric power is the same as the horsepower of the petrol-powered 2013 Buick Enclave engine. (11) Fly wheel is the driving force of the rotary generator. (12) The switch turns power on and off. (13) Distributed Transformer is a transmitter of power to variable loads. (14) Fly wheel is a lever that produces torque. (15) The pulley is the driving force of the fan, heat pump compressor, and power steering that connects to the shaft of the electromagnetic rotor bar. (16) Overall Frame, a mechanical structure, the back of it which air vented that is the air outflow. (17) Vent is a cooler which is an air intake that is generated from the fan to cool the rotor. (18) Flow charger circuit is a voltage regulator. Portable electric generator drawing, Page 8, FIG. 3, Numbers 19-21. (19) Battery is source of power. (20) Reluctance is a DC motor; (21) Flow charger is a voltage regulator.

1. The electromechanical power system, an overall electric-powered engine, is a magnetomotive force which operates as an alternating current (AC) induction motor that can power passenger vehicles such as the 2013 Buick Enclave engine. This electromechanical power system claims to operate at the same power as a petrol-powered engine (288 hp at 6,300 rpm), which converts to magnetomotive force of 27,648kw at 6,300 rpm. The (6) power transformer connects to the (7) electromagnetic wound in which the coil links to the magnetic field where amperes are amplified in a circuit to generate a magnetomotive force through an electromagnetic induction connection. (9) The slip ring interacts with the rotor bar and connects to the (8) power controller. (14) The fly wheel correlates with the magnetomotive force which acts as a lever or the rotating force which generates torque, the output of power of 270 lb-ft. at 3,400 rpm connecting to (10) the electromagnetic rotor bar.

2. This system claims to be a renewable power source that does not idle to recharge the (1) battery which it is doing while it is operating. The (11) fly wheel is the driving force of the rotary generator which connects to the (13) distributed transformer which connects to the (18) the flow charger that connects the (1) battery terminals to supply electrical power.

3. The claim is that there are no carbon dioxide emissions. (17) An inflow of air to (10) electromagnetic rotor bar in which air moves heat in an outflow to (16) the frame to the side of it as an exhaust of the electric engine.

4. This is an overall direct current (DC) electric power system which claims to operate inside buildings when powering portable electric generators without producing pollution from them.

5. The system claims to be a renewable power source in a series circuit that powers a portable electric generator; (21) the flow charger is a voltage regulator to recharge the (19) battery which connects to the (20) DC motor driving force of the rotary generator.

6. This electric power system's direct current emits no carbon dioxide.
